(19) United States
(12) Patent Application Publication
(10) Pub. No.: US 2017/0193505 A1
(43) Pub. Date: Jul. 6, 2017

(54) SECONDARY VALIDATION FOR FRAUD PREVENTION

(71) Applicant: Avaya Inc., Santa Clara, CA (US)

(72) Inventors: George Erhart, Loveland, CO (US); David Skiba, Golden, CO (US); Valentine C. Matula, Granville, OH (US)

(21) Appl. No.: 14/988,926

(22) Filed: Jan. 6, 2016

(51) Int. Cl. G06Q 20/40; G06Q 20/32; G06Q 50/00

(52) U.S. Cl. CPC G06Q 20/405; G06Q 50/01; G06Q 20/3224

(57) ABSTRACT

Banks and other financial institutions struggle to determine when to authorize and when to deny a transaction, such as credit card transactions, for customers. Customers, such as those who travel infrequently or otherwise make purchases at unusual locations, may have transactions denied at such locations. Conversely, stolen credit cards or their numbers, are often utilized in atypical locations for the customer. The provision of a secondary indicator of the customer's location to a bank, such as via an application or a check-in operation on a social media website, allows the bank to determine that the customer is likely at a location associated with a prospective transaction. Confirming a customer's location via a check-in operation, which may require the customer's device and/or social media credentials, provides an extra level of security while minimizing undue denial of legitimate transactions.

### FIELD OF THE DISCLOSURE

The present disclosure is generally directed toward authenticating transactions, such as financial transactions.

### BACKGROUND

Banks, and other financial institutes, employ many approaches to determining whether a transaction, such as a credit card transaction, is legitimate or potentially fraudulent. Current algorithms for fraud prevention are often too restrictive and conservative. Customers are embarrassed and unhappy when, through no fault of their own, a transaction is denied. It is estimated that half or more of the transactions flagged as fraud and blocked are, in fact, valid purchases.

Banks typically prefer an overly cautious approach. In the event of fraud, it is usually the bank that is the party injured as opposed to the cardholder. In order to minimize exposure to fraudulent transactions, banks track customers' spending trends. However, trends often have exceptions, which may result in denied transactions. Many customers today can call their bank and let them know that they will be traveling. Some banks even have a travel notification on the bank's website so a customer can provide travel details. While these two solutions may result in fewer erroneously denied transactions, they are manual and require the customer to be proactive.

### SUMMARY

As a general introduction to the disclosure and in one embodiment, systems and methods are disclosed to enable an authorizing entity to proactively enable transactions in a specific area based on an application's interaction with validation points.

Embodiments disclosed herein provide additional ways for a bank to proactively verify that a customer's activity is legitimate. Banks, or other authorizing entities, may utilize certain embodiments disclosed herein in addition to other authentication means (e.g., determine presence of sufficient funds, transaction within limits, credit card not reported lost/stolen, etc.). In one embodiment, a customer may check into a town, city, destination, resort, etc. that may serve as a validation point to enable transactions in the area.

In additional embodiments, a location may be determined by a check-in and verify feature associated with social media, smartphone, or other location information source. Additionally, a button on the application may allow a “purchase check-in” that can be automatically validated by the bank's server at any time. This may be used with location features for added security, such as by providing a device's location when logging into the application. Embedded telephone location services can also be provided through a car, social media, microchip, etc.

Temporary codes, such as a token, can be provided by the application after location verification for ease of customer use. The temporary codes are set to expire at a previously determined period of time or upon detection of the device at an expiration point. For example, a customer may have checked in at the Miami International Airport and purchases made by the customer in the Miami area may be assumed to be authentic and approved, assuming sufficient funds, staying within daily spending limit, etc. However, if the customer then checks in at a cruise ship dock, the temporary codes provided at the airport may be invalidated as the customer may be boarding a cruise ship. If a credit card is then used in the Miami area, it may be an indication that the card was lost or stolen and, unless subsequently authorized via another validation point, requires other means of validation.

In one embodiment, a method is disclosed, comprising: receiving, by a processor, a request for authorization to perform a transaction between a customer and a party utilizing a transaction terminal, the party having a location; accessing, by the processor, a device location of a device associated with the customer; making an authorization decision, by the processor, comprising, authorizing the transaction upon determining the device location is associated with a validation point and the validation point is associated with the party's location; and replying, by the processor, to the request with indicia of the authorization decision.

In another embodiment, a server is disclosed, comprising: a network interface; a processor to: receive a request for authorization to perform a transaction between a customer and a party utilizing a transaction terminal, the party having a location; access a device location of a device associated with the customer; make an authorization decision, comprising, authorizing the transaction upon determining the device location is associated with a validation point and the validation point is associated with the party's location; and reply to the request with indicia of the authorization decision.

In another embodiment, a means is disclosed to make an authorization decision for a transaction, comprising: means to receive a request for authorization to perform a transaction between a customer and a party at a party location; means to access a device location of a device associated with the customer; means for making an authorization decision, comprising, means to authorize the transaction upon determining the device location is associated with a validation point and the validation point is associated with the party location; and means to reply to the request with indicia of the authorization decision. In a further embodiment, the means provided comprise at least one processor, such as a microprocessor, server, server array, distributed processor (e.g., “cloud”), etc. In another further embodiment, the means comprise a communication network and associated interface to a data network such as to facilitate communication between the a processor and a transaction terminal.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation, or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first environment in accordance with embodiments of the present disclosure;

FIG. 2 depicts a second environment in accordance with embodiments of the present disclosure;

FIG. 3 depicts a first interaction in accordance with embodiments of the present disclosure;

FIG. 4 depicts a second interaction in accordance with embodiments of the present disclosure;

FIG. 5 depicts a first process in accordance with embodiments of the present disclosure; and

FIG. 6 depicts a second process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

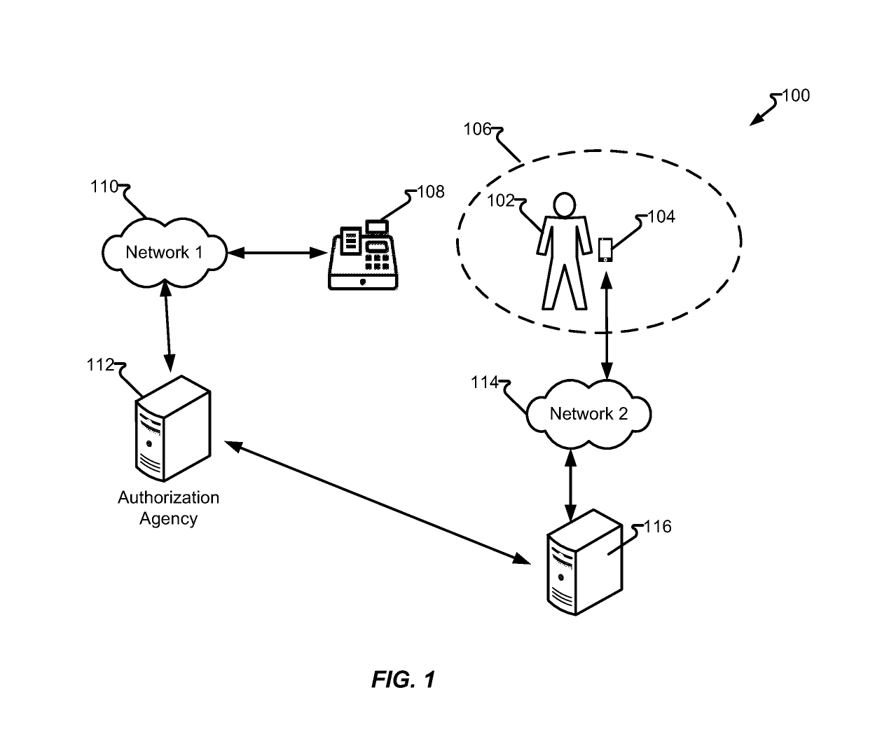

FIG. 1 depicts environment 100 in accordance with embodiments of the present disclosure. In one embodiment, customer 102 with device 104 is at validation point 106. Validation point 106 generally comprises a limited area (e.g., a point on earth), which can reliably indicate the presence of the customer, or, more particularly, device 104 controlled by customer 102, within a sufficiently finite area. Device 104 may then communicate with server 116 via network 114 to provide server 116 with a means of maintaining a record of the location of device 104 and therefore of customer 102.

In another embodiment, customer 102 wishes to perform a transaction with a party at a party's location. The party may utilize transaction device 108 to, at least in part, obtain authorization from authorization agency 112 (e.g., bank, credit card service bureau, etc.) before the transaction is approved and funds are transferred or authorized to be transferred from customer 102 to the party. The party may be automated with the transaction device (e.g., kiosk) or comprise a human intermediary (e.g., business agent, salesperson, business owner, etc.) utilizing transaction device 108 (e.g., point-of-sale terminal, card reader, etc.). Transaction device 108 communicates with authorization agency 112 via network 1 (110), which may be a private network, public network (e.g., Internet), or a combination thereof. Network 1 (110) may be different from, or partially or entirely the same as, network 2 (114). Network 1 (110) may differ in terms of security (e.g., encryption, VPN, etc.). Transaction device 108 may further comprise a general purpose communication device, such as a telephone, used by a human agent to call authorization agency 112 to obtain a verbal and/or textual authorization over network 1 (110) (e.g., cellular telephone network, VoIP, PSTN, etc.).

In another embodiment, authorization agency 112 may be integrated with, integrated by, or co-integrated with server 116. In yet another embodiment, server 116 is distinct from authorization agency 112. For example, server 116 may comprise a social media website accessed by customer 102 utilizing device 104, such as to perform the check-in function. The check-in function may identify the location coinciding with verification point 106. Customer 102 may utilize device 104, such as by the execution of an application associated with server 116, such as a social media server, to identify a particular venue during a check-in process. For example, customer 102 may check in at an airport, restaurant, hotel, entertainment venue, address, etc. as a validation point 106 associated with a particular area.

In another embodiment, authorization agency 112 receives a request from transaction device 108 to approve a transaction associated with a monetary token (e.g., check, credit card, etc.) associated with the customer 102. Authorization agency 112 may perform a number of individual determinations in order to approve or disapprove the transaction. For example, customer 102, may be attempting to utilize the monetary token beyond an approved amount, the monetary token may have been previously reported as missing or stolen, or other determination as to whether customer 102 should be permitted to conduct the transaction requested by transaction device 108. Transaction device 108 may have a location and be a proxy for the location of a party for which customer 102 wishes to perform the transaction.

Authorization agency 112 may further determine whether to approve or disapprove the transaction based upon such a location of transaction device 108 and the likelihood of customer 102 being in an area likely to comprise transaction device 108, as opposed to an unauthorized party in possession of the monetary token in an attempt to impersonate customer 102 for the purpose of conducting the transaction with the party utilizing transaction device 108.

Authorization agency 112 may access server 116 to obtain a location provided by device 104. Upon determining device 104 is at validation point 106, or has been at validation point 106 within a previously determined period of time, authorization agency 112 may determine with reasonable certainty that customer 102 is proximate to transaction terminal 108 and thereby conclude that the transaction is legitimate. Upon determining the transaction is legitimate, and all other authorization determinations have been determined in favor of the transaction, authorization agency 112, may inform transaction terminal 108, such as by utilizing network 1 (110), that the transaction has been approved. Conversely, authorization agency 112 may access server 116 and access a record maintaining a location of device 104. If the record does not indicate the presence of device 104 at validation point 106, or does not indicate the presence of device 104 at validation point 106 within a previously determined period of time, authorization agent 112 may notify transaction terminal 108 to decline the transaction or withhold approval until alternative verification of the party purporting to be customer 102 is obtained (e.g., authorization agency 112 may initiate a voice or text communication with device 104 to perform a challenge-response authentication).

The location of the party and the transaction may be assumed to be a location for transaction terminal 108. In one embodiment, validation point 106 is associated with the location of transaction terminal 108 and the presence of device 104 at validation point 106 may be required to access transaction terminal 108. For example, validation point 106 may be a concert venue. Access to transaction terminal 108, such as to purchase merchandise associated with a performer at the concert venue, may require that device 104 be at validation point 106. Authorization agency 112 may obtain a record previously provided by device 104 indicating a location of the concert venue. Or, in response to a transaction utilizing transaction terminal 108, authorization agency 112 may prompt user 102 using device 104, such as via server 116 or other connection, to indicate their location (e.g., “Please check into ‘The Concert Hall’ to authorize your current transaction.”). While not all legitimate transactions may be associated with an associated validation point 106, the absence of such a location may indicate a suspicious transaction and be declined by authorization agent 112 or require alternative authentication. For example, customer 102 may take the train to another city. Validation point 106, such as at the airport in the same city, may not be visited by customer 102 and device 104. However, the presence of device 104 at validation point 106 may be a significantly strong indicator that a transaction with a party utilizing transaction terminal 108 is authentic and avoid unnecessarily denying a transaction.

A transaction between a party utilizing transaction terminal 108 and customer 102 may be co-located with validation point 106. In another embodiment, transaction terminal 108 and customer 102 may be separated by a significant distance. For example, customer 102 with device 104 may check in at Denver International Airport. A transaction utilizing terminal 108 may be requested and approved, even though the location of transaction terminal 108 may be over two-hundred miles away in Montrose, nearby Black Canyon of the Gunnison being known for camping and other remote recreational activities. Additional authentication can be provided upon accessing a credit card purchase for a rental car to be picked up at the airport. Conversely, customer 102 and device 104 may not have provided any check-in reasonably associated with the area causing the transaction utilizing transaction terminal 108 in Montrose to be declined, or at least require alternative authentication.

In another embodiment, check-in or presence at validation point 106 may be time-dependent. For example, device 104 may be at validation point 106 associated with access to beach resorts. Accordingly, device 104, having a location of validation point 106 such as at Honolulu International Airport, may be reasonably proximate to transaction terminal 108 located in Maui. As a benefit, customer 102 need not have device 104 during the transaction utilizing transaction terminal 108 for the transaction to be approved by authorization agency 112.

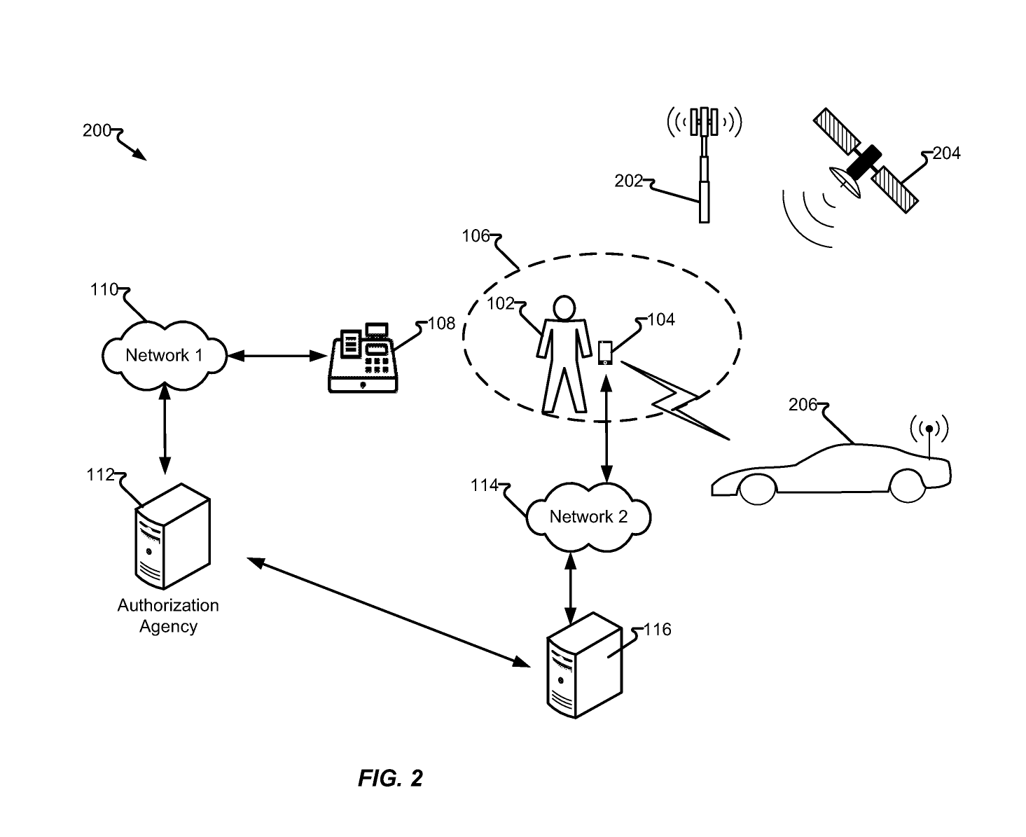

FIG. 2 depicts environment 200 in accordance with embodiments of the present disclosure. In one embodiment, the location of device 104 may be determined by customer 102 utilizing device 104 to check into validation point 106. In another embodiment, the location of device 104 may be determined via a location-aware application on device 104 receiving a location, such as by another device (e.g., a Bluetooth connection to a location-aware vehicle 206 or other device), GPS via satellite 204, connectivity to radio-frequency transmitter (e.g., cellular tower 202, WiFi transmitter installed at a known location, etc.).

In one embodiment, customer 102 utilizing device 104 connects via Bluetooth to rental car 206 having a known pick-up origin associated with validation point 106. Device 104 then signals server 116, via network 2 (114) to create and/or update a record maintained by server 116 indicating check-in at validation point 106. As a result, authentication agency 112 may communicate with transaction terminal 108 via network 1 (110) to authorize a transaction when transaction terminal 108 is associated with validation point 106. Similarly, location may be provided to server 116 as determined by satellite 204 and or radio-frequency (or other electromagnetic frequency) transmitter 202.

In another embodiment, device 104 may be provided with a temporary code to be provided to transaction terminal 108. The temporary code may more readily provide the identification of device 104 having been at validation point 106. For example, an application on device 104 may instruct customer 102 to enter code “3456” if asked for a secondary verification by transaction terminal 108. Authentication agency 112 may prompt or receive the temporary code as a component of an authentication process utilizing transaction device 108. The transaction code may be short and human-readable, such as to facilitate customer 102 remembering the temporary code and not requiring customer 102 to write down the temporary code or carry device 104. In another embodiment, the temporary code may be lengthy and/or encrypted to make the presence of device 104 essential to the authentication process for a transaction utilizing transaction terminal 108. The temporary code may expire upon the passage of a predetermined duration of time and/or upon device 104 being associated with a location different from validation point 106 and/or a return visit. For example, a check-in at a foreign airport may be associated with a record maintained by server 116 and/or a temporary code and further associated with transaction terminal 108. A subsequent visit to the same airport, or a different port of entry/departure (e.g., dock, train station, etc.) may indicate customer 102 is no longer to be associated with any transaction terminal associated with validation point 106, thereby expiring the temporary code and/or causing the record maintained by server 116 to be updated to reflect a potential departure.

In another embodiment, authentication agency 112 may determine a type of transaction requested by transaction terminal 108 and associated with customer 102 and approve or deny (or require alternative authentication) accordingly. For example, it may not be unusual for customer 102 to make a significant purchase at a grocery store once a month. However, the grocery store may be close to the residence of customer 102, as people making large grocery purchases rarely do so far from their home. In a foreign country, however, customer 102 may have to check in or otherwise be present at a particular validation point 106, as a large grocery purchase may be uncommon and, therefore, such a transaction request by transaction terminal 108 may be denied. A routine purchase of groceries in a foreign location may be an indication that customer 102 is no longer in possession of their credit card and another individual is impersonating customer 102. Accordingly, the transaction may be declined. Alternatively, a purchase at transaction terminal 108 associated with a local fine-dining restaurant may be approved, even if the amount is similar or more than the amount associated with the denied grocery store purchase, as such a transaction may be more typical for a tourist known to be visiting another country.

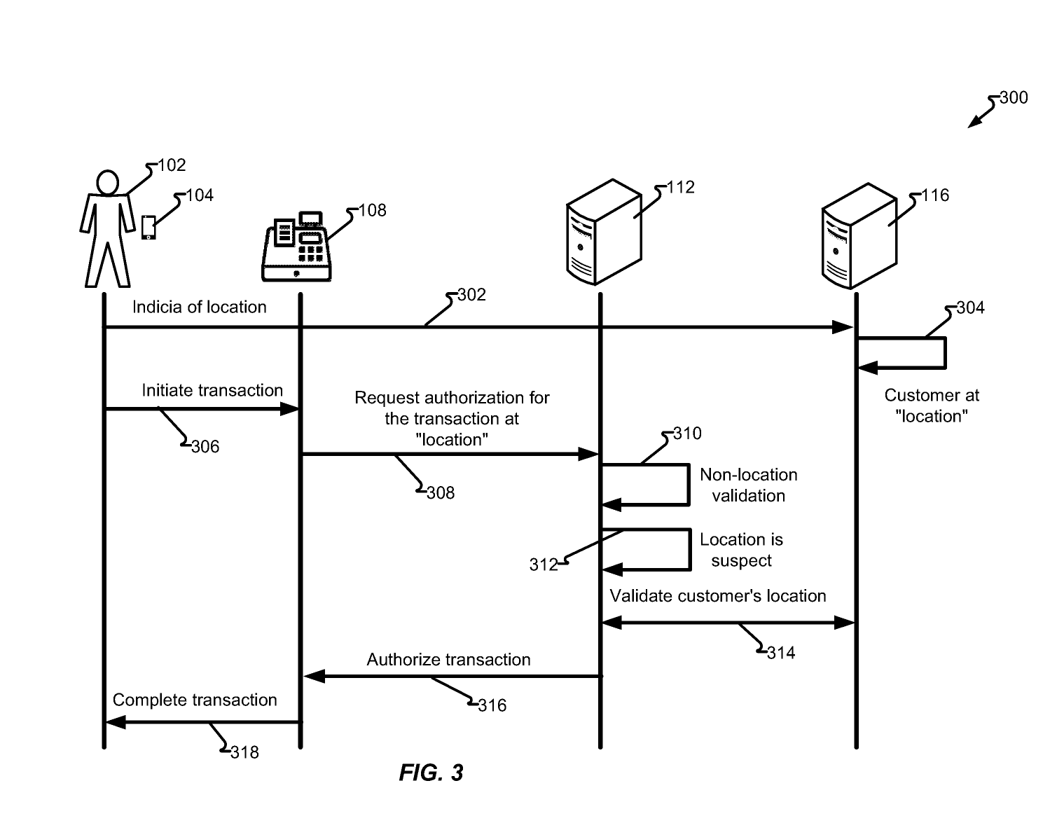

FIG. 3 depicts interaction 300 in accordance with embodiments of the present disclosure. In one embodiment, device 104 associated with customer 102 provides indicia of location 302 to server 116. In one embodiment, indicia of location 302 is provided via a social media application communicating with server 116 when embodied as a social media server. In another embodiment, indicia of location 302 is provided to server 116 when embodied as a server co-owned and/or operated by authorization authority 112. Indicia of location 302 may be a check-in to provide the location, which may be a city, country, venue, hotel, restaurant, or other named location and/or a physical location on earth (e.g., GPS position). Indicia of location 302 may be an indicia of relative proximity to a radio or other electromagnetic source (e.g., WiFi, AM-FM, cellular, Bluetooth device, etc.) when device 104 is receiving signals therefrom.

Record update 304 creates and/or updates at least one record maintained by server 116. The record may be maintained internally to server 116 or accessible to server 116 (e.g., external database, distributed storage, etc.). Customer 102 may initiate transaction 306 with a party utilizing transaction terminal 108. Transaction terminal 108 may request authorization 308 from authentication agency 112. As can be appreciated, communications with authentication agency 112 may be machine-based, such as when authentication agency 112 is accessed via a data network for electronic communication with transaction terminal 108. In another embodiment, transaction terminal 108 may be a human communication device (e.g., telephone, chat, etc.) to an automated or human resource of authentication agency 112 to provide text-based or verbal-based transaction approval and disapproval for a particular transaction.

Authentication agency 112 may perform non-location validation 310, such as to determine if the transaction initiated in step 306 is performed with a valid credit card, check, or other monetary proxy, or if the transaction value is within preset spending limits, etc. Location is suspect 312 determines that the location for transaction terminal 108 in combination with customer 102 is suspect. Next, authentication agency 112 may interface with server 116 to access a location, such as a check-in location associated with a validation point 106 as maintained in the record created/updated in step 304. If customer 102 is likely proximate, as determined by location record entry provided in step 314, the transaction may be authorized in step 316 allowing transaction terminal 108 to complete the transaction 318.

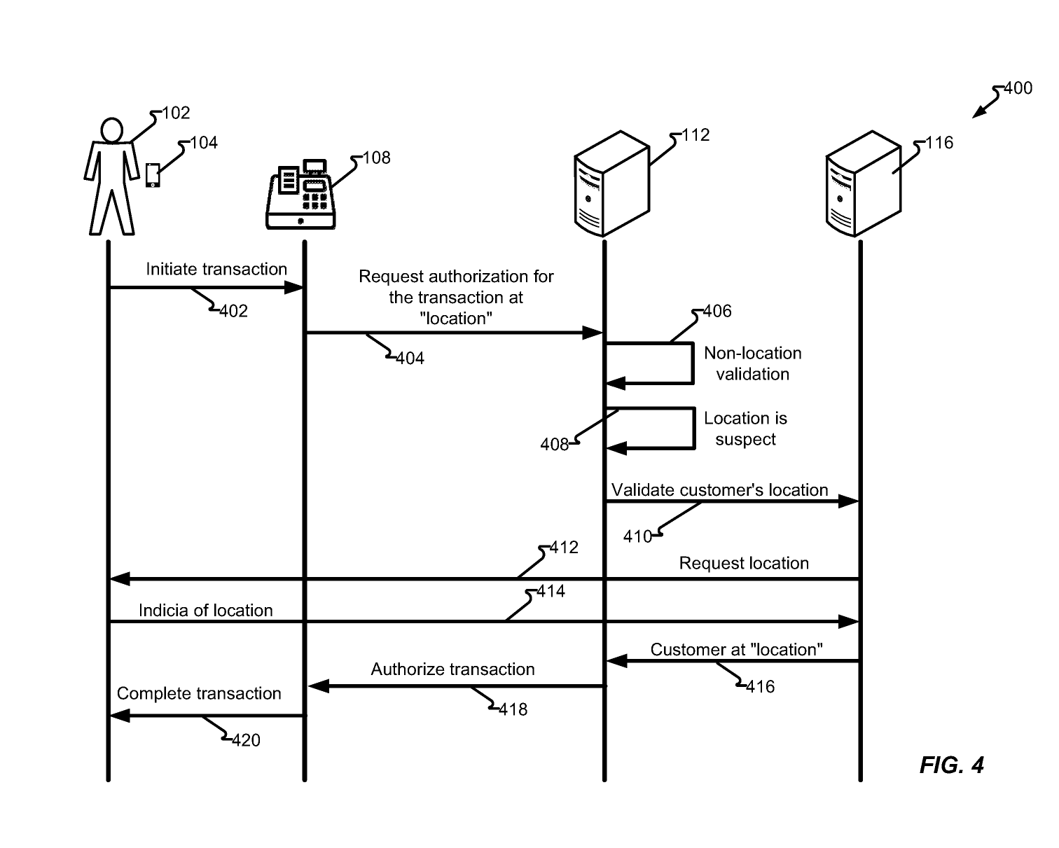

FIG. 4 depicts interaction 400 in accordance with embodiments of the present disclosure. In one embodiment, customer 102 initiates transaction 402 with a party utilizing transaction terminal 108. Transaction terminal 108 requests authorization 404 from authorization entity 112. Authorization entity 112 may perform non-location validation 406. Upon authorization entity 112 determining location is suspect 408, authentication entity 112 may request validation of customer 102's location 410 from server 116.

If not present, server 116 may request location 412 from device 104. Request 412 may be a retrieval or a prompt from either customer 102 to provide a location or location indicia or from a location aware application running on device 412. For example, request 412 may prompt customer 102 to check in using device 104 (or other device) at a certain location, such as a location associated with validation point 106. Upon receiving indicia of location 414, server 116 may provide customer location 416 to authentication agency 112. In response, authentication agency 112 may authorize transaction 418 allowing for transaction terminal 108 to complete the transaction 420.

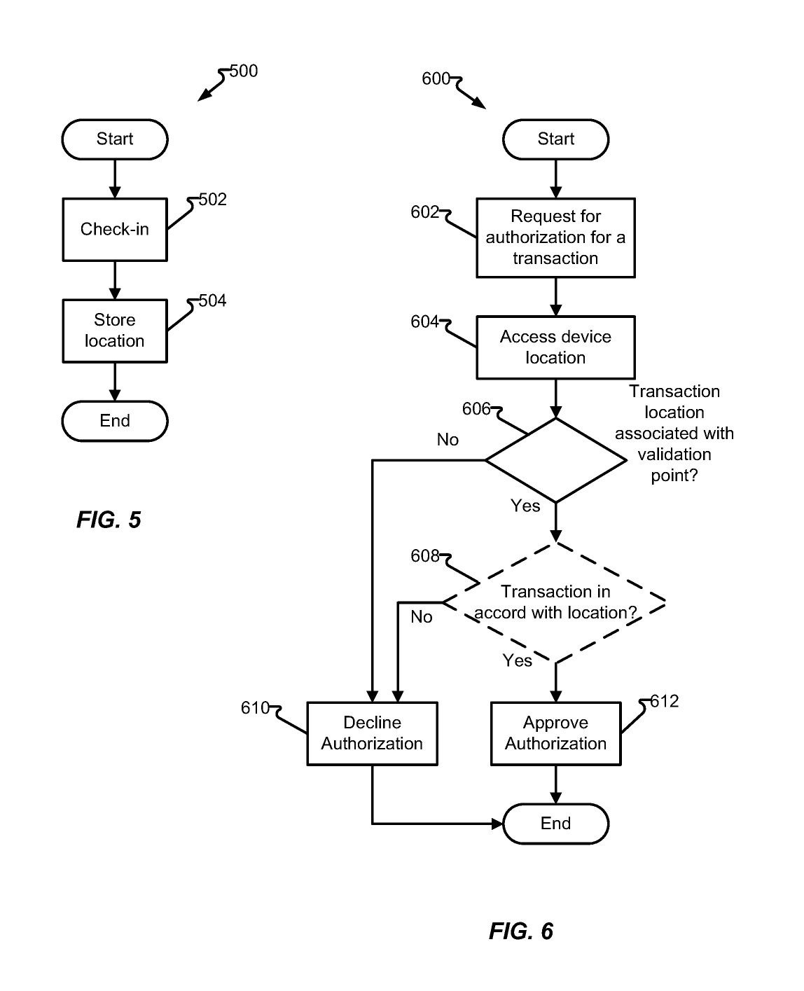

FIG. 5 depicts process 500 in accordance with embodiments of the present disclosure. In one embodiment, process 500 is performed to update a location associated with a customer, such as customer 102. Customer 102 utilizes a device, such as device 104, to check in 502. Check-in 502's location is stored in step 504, such as in a database or other data repository maintained by a server, such as server 116.

FIG. 6 depicts process 600 in accordance with embodiments of the present disclosure. In one embodiment, process 600 is initiated at step 602 wherein a request for transaction authorization is received, such as from transaction terminal 108. Step 604 accesses a device location, such as maintained by server 116 following a check-in operation (See, FIG. 5 step 502) and stored (see, FIG. 5, step 504). Device location 604 may be an identity of a validation point, such as validation point 106, having a previously determined location. In another embodiment, step 604 is performed before step 602. Step 606 determines if the location of the transaction, such as by a known location of transaction terminal 108, is associated with the validation point, such as validation point 106. If step 606 is determined in the affirmative, process 600 may continue to step 608, if implemented, or if not, to step 608. Optional step 608 determines if the transaction is in accord with the particular customer at the particular location of the transaction request. If step 608 is determined in the affirmative, process 600 may continue to step 612. If step 608 is determined in the negative, process 600 may continue to step 610. If step 610 is performed, the transaction may be declined or alternatively an alternative authentication may be required, which, if successful, may cause the transaction to be approved. If step 612 is performed, the transaction may be authorized, such as by sending a signal to transaction terminal 108 or a voice indication provided to a party associated with transaction terminal 108.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

While illustrative embodiments of the disclosure have been described in detail herein, it is to be understood that the inventive concepts may be otherwise variously embodied and employed and that the appended claims are intended to be construed to include such variations, except as limited by the prior art.

What is claimed is:

1. A method, comprising:
receiving, by a processor, a request for authorization to perform a transaction between a customer and a party utilizing a transaction terminal, the party having a location;
accessing, by the processor, a device location of a device associated with the customer;
making an authorization decision, by the processor, comprising, authorizing the transaction upon determining the device location is associated with a validation point and the validation point is associated with the party's location; and
replying, by the processor, to the request with indicia of the authorization decision.

2. The method of claim 1, wherein the device location is associated with the validation point upon the device location being present at the validation point within a previously determined time.

3. The method of claim 1, wherein the validation point comprises an entry point to an area comprising the party's location.

4. The method of claim 1, wherein:
the validation point is a check-in location on a social media website; and
the step of accessing the device location comprises accessing the check-in location record maintained by a social media server associated with the social media website.

5. The method of claim 1, wherein:
the step of accessing the device location comprises accessing a Global Positioning System (GPS) coordinate provided by the device; and
the step of determining the device location is associated with the validation point further comprises determining the device location is within a previously determined distance from the validation point.

6. The method of claim 1, wherein:
the step of accessing the device location comprises accessing indicia maintained by the device, the indicia comprising an electromagnetic transmitter identifier having a known location and providing electromagnetic signals to the device; and
the step of determining the device location is associated with the validation point further comprises determining the electromagnetic transmitter is within a previously determined area associated with the validation point.

7. The method of claim 1, wherein accessing the device location comprises accessing a location of a location-aware component, distinct from the device and in communication with the device, wherein the communication is known to require the device and the location-aware component be within a previously determined distance from each other.

8. The method of claim 1, wherein the authorization decision further comprises determining a transaction-type associated with the transaction and authorizing the transaction upon determining the transaction-type is in accord with the party.

9. The method of claim 1, wherein the device location is determined by prompting the device to respond to a location in response to the step of receiving the request.

10. The method of claim 1, wherein the device location is associated with the validation point upon the device not having a subsequent association with an invalidation point.

11. A server, comprising:
a network interface;
a processor to:
receive a request for authorization to perform a transaction between a customer and a party utilizing a transaction terminal, the party having a location;
access a device location of a device associated with the customer;
make an authorization decision, comprising, authorizing the transaction upon determining the device location is associated with a validation point and the validation point is associated with the party's location; and
reply to the request with indicia of the authorization decision.

12. The server of claim 11, wherein the device location is associated with the validation point upon the device location being present at the validation point within a previously determined timeframe.

13. The server of claim 11, wherein the processor accesses the device location comprises accessing a data record maintained by a social media server and comprising a check-in location provided by the customer performing a check-in function on an application associated with the social media server.

14. The server of claim 11, wherein the processor determines the authorization decision, further comprising, determining a transaction-type associated with the transaction and authorizing the transaction upon determining the transaction-type is in accord with the party's location.

15. The server of claim 11, wherein the processor determines the device location, comprising prompting the device to respond with a location in response to receiving the request.

16. A means to make an authorization decision for a transaction, comprising:
means to receive a request for authorization to perform a transaction between a customer and a party at a party location;
means to access a device location of a device associated with the customer;
means for making an authorization decision, comprising, means to authorize the transaction upon determining the device location is associated with a validation point and the validation point is associated with the party location; and
means to reply to the request with indicia of the authorization decision.

17. The means of claim 16, wherein:
the validation point is a check-in location on a social media website; and
the means to access the device location, further comprise means to access a check-in location maintained by a social media server associated with the social media website.

18. The means of claim 17, wherein the device location is determined by a venue location indicated by a check-in process indicating the venue.

19. The means of claim 16, further comprising means to authorize the transaction upon determining the transaction is associated with a transaction type in accord with the location of the device.

20. The means of claim 19, further comprising means to authorize the transaction upon determining the transaction is associated with a transaction type in accord with the location of the device and the customer performing the transaction at the location.
